(19) United States
(12) Patent Application Publication
(10) Pub. No.: US 2025/0297626 A1
(43) Pub. Date: Sep. 25, 2025

(54) ENGAGING CONNECTION STRUCTURE

(71) Applicant: FIVETECH TECHNOLOGY INC., New Taipei City (TW)

(72) Inventors: TING-JUI WANG, New Taipei City (TW); HSIEN-CHANG CHEN, New Taipei City (TW)

(73) Assignee: FIVETECH TECHNOLOGY INC., New Taipei City (TW)

(21) Appl. No.: 19/079,443

(22) Filed: Mar. 13, 2025

(30) Foreign Application Priority Data
Mar. 19, 2024 (TW) 113110197

(51) Int. Cl. F16B 1/04

(52) U.S. Cl. CPC F16B 1/04

(57) ABSTRACT

The present disclosure provides an engaging connection structure including an assembly portion, an engaging portion and a limiting member. The engaging portion is movably combined with the assembly portion. The limiting member is provided at the assembly portion and the engaging portion. The engaging portion is provided with a positioning portion and a moving portion. The limiting member provides limiting or moves at the positioning portion and the moving portion to limit a movement of the engaging portion. Or, the assembly portion is provided with a positioning portion and a moving portion. The limiting member provides limiting or moves at the positioning portion and the moving portion to limit a movement of the engaging portion. Accordingly, the assembly portion can be combined with an object, and be engaged with or released from another object.

### CROSS-REFERENCE TO RELATED APPLICATION

This non-provisional application claims priority under 35 U.S.C. § 119(a) on Patent Application No(s). 113110197 filed in Taiwan, R.O.C. on Mar. 19, 2024, the entire contents of which are hereby incorporated by reference.

### BACKGROUND OF THE INVENTION

### 1. Field of the Invention

The present disclosure relates to an engaging connection structure, and in particular to an engaging connection structure capable of repeatedly quick coupling and separating at least two objects.

### 2. Description of the Related Art

In general, to couple at least two objects, a screw is usually used for locking so as to combine the objects.

In the conventional fixing means above, although the at least two objects can be fixed and coupled in a form that is not easily separated, in addition to unhandy assembly, the at least two objects may not be easily separated due to the fixedly coupling means using the screw.

In view of the prior art above, the applicant has developed an engaging connection structure with the aim of achieving effects of repeatedly quick coupling and separation.

### BRIEF SUMMARY OF THE INVENTION

In the engaging connection structure and the engaging connection method thereof of the present disclosure, an assembly portion can be combined with an object, and be engaged with or released from another object with the engaging portion coordinating with a limiting member, so as to complete quick coupling and separation of at least two objects to achieve effects of repeatedly quick coupling and separation.

To achieve the above and other objects, the present disclosure provides an engaging connection structure and an engaging connection method thereof, wherein the engaging connection structure includes an assembly portion, an engaging portion and a limiting member. The engaging portion is movably combined with the assembly portion. The limiting member is provided at the assembly portion and the engaging portion. The engaging portion is provided with at least one positioning portion and a moving portion. The limiting member provides limiting or moves at the positioning portion and the moving portion to limit a movement of the engaging portion. Or, the assembly portion is provided with at least one positioning portion and a moving portion. The limiting member provides limiting or moves at the positioning portion and the moving portion to limit a movement of the engaging portion.

The present disclosure further provides an engaging connection structure and an engaging connection method thereof, wherein the engaging connection structure includes an assembly portion, an engaging portion and a limiting member. The engaging portion is movably combined with the assembly portion. The limiting member is provided at the assembly portion and the engaging portion. The engaging portion is provided with at least one positioning portion and a moving portion. The limiting member provides limiting or moves at the positioning portion and the moving portion to limit a movement of the engaging portion. Or, the assembly portion is provided with at least one positioning portion and a moving portion, or the limiting member provides limiting or moves at the positioning portion and the moving portion to limit a movement of the engaging portion.

Optionally, a first elastic component is further included. Two ends of the first elastic component abut against the assembly portion and the limiting member, respectively. The first elastic component abuts against the limiting member such that the limiting member is located at the positioning portion and the engaging portion forms a limited state, or presses the limiting member downward to compress the first elastic component such that the limiting member forms a moving state via the moving portion.

Optionally, a first elastic component is further included. Two ends of the first elastic component abut against the engaging portion and the limiting member, respectively. The first elastic component abuts against the limiting member such that the limiting member is located at the positioning portion and the engaging portion forms a limited state, or presses the limiting member downward to compress the first elastic component such that the limiting member forms a moving state via the moving portion.

Optionally, at least one second elastic component is further included. Two ends of the second elastic component abut against the assembly portion and the engaging portion, respectively.

Optionally, the positioning portion is a wide hole portion.

Optionally, the limiting member is provided with a limiting portion and a non-limiting portion. The volume or size of the limiting portion is adapted to provide limiting at the positioning portion, and the volume or size of the non-limiting portion is adapted to move at the moving portion.

Optionally, the limiting member is provided with a limiting portion and a non-limiting portion. The non-limiting portion moves downward to release the positioning portion from limiting of the limiting portion, such that the non-limiting portion moves at the moving portion, or the limiting portion provides limiting at another positioning portion. Or, the number of the positioning portion is two, the moving portion is communicatively provided between the two positioning portions, the non-limiting portion moves downward to release one of the positioning portions from limiting of the limiting portion, such that the non-limiting portion moves at the moving portion, or the limiting portion provides limiting at the other of the positioning portions.

Optionally, the limiting member is provided with a limiting portion and a non-limiting portion. The positioning portion is greater than the limiting portion, the limiting portion is greater than the moving portion, and the moving portion is greater than the non-limiting portion.

Optionally, the assembly portion is provided with a mounting unit. The mounting unit is for assembling at an object, which is a server, a computer, a motherboard, a printed circuit board (PCB), a housing, a track, a heat dissipater, a fan, a memory, a chip, a metal body or a non-metal body.

Optionally, the engaging portion is for engaging another object, which is a circuit board, an integrated circuit (IC), a chip, a PCB, a housing, a track, a heat dissipater, a fan, a metal body, a plastic body, a non-metal body, a heat sink or a memory.

Optionally, a limiting portion is provided between the engaging portion and the assembly portion. The limiting portion is for limiting or movable combination, or the assembly portion is for being engagingly connected, locked, welded, expansion connected or riveted to an object, or the assembly portion and the object are integrally formed.

Optionally, the engaging portion is provided with an operating portion, which is for being operated, lifted, or actuated to the engaging connection structure.

Optionally, at least one second elastic component is further included. Two ends of the second elastic component abut against the assembly portion and the engaging portion, respectively. The limiting member moves at the moving portion and departs from the positioning portion, such that the engaging portion is automatically engaged or automatically released due to an elastic force of the second elastic component to locate the engaging portion at a normally engaged position or a normally open position. Or, the number of the positioning portion is one, the limiting member moves at the moving portion and departs from the positioning portion, such that the engaging portion is automatically engaged or automatically released due to an elastic force of the second elastic component to locate the engaging portion at a normally engaged position or a normally open position.

Optionally, the limiting member moves at the moving portion and departs from the positioning portion to locate the engaging portion at a normally engaged position or a normally open position, or to allow the engaging portion to be engaged with or released from the positioning portion at the moving portion.

Optionally, the limiting member is provided with a block portion, which is for blocking against the assembly portion or the engaging portion to combine the assembly portion with the engaging portion, or for supporting an elastic force of the first elastic component to elastically abut the limiting member at the engaging portion or the assembly portion.

### BRIEF DESCRIPTION OF THE DRAWINGS

To more clearly describe the technical solutions of the embodiments of the present disclosure and the prior art, accompanying drawings that need to be used as required in the embodiments are to be briefly introduced. It is apparent that the accompanying drawings below are merely some embodiments of the present disclosure, and other accompanying drawings can be obtained on the basis of the these accompanying drawings by a person of ordinary skill in the art without involving any inventive skill.

FIG. 1 is a schematic diagram of appearance of a first embodiment of the present disclosure.

FIG. 2 is an exploded schematic diagram of the first embodiment of the present disclosure.

FIG. 3 is a side schematic diagram of the first embodiment of the present disclosure.

FIG. 4 is a cross-sectional schematic diagram of the first embodiment of the present disclosure.

FIG. 5 is a first schematic diagram of a state of use of the first embodiment of the present disclosure.

FIG. 6 is a second schematic diagram of a state of use of the first embodiment of the present disclosure.

FIG. 7 is a third schematic diagram of a state of use of the first embodiment of the present disclosure.

FIG. 8 is a fourth schematic diagram of a state of use of the first embodiment of the present disclosure.

FIG. 9 is a fifth schematic diagram of a state of use of the first embodiment of the present disclosure.

FIG. 10 is a sixth schematic diagram of a state of use of the first embodiment of the present disclosure.

FIG. 11 is a side schematic diagram of a second embodiment of the present disclosure.

FIG. 12 is a schematic diagram of a state of use of a third embodiment of the present disclosure.

FIG. 13 is a schematic diagram of a state of use of a fourth embodiment of the present disclosure.

FIG. 14 is a schematic diagram of appearance of a fifth embodiment of the present disclosure.

FIG. 15 is a schematic diagram of a state of use of the fifth embodiment of the present disclosure.

FIG. 16 is a schematic diagram of appearance of a sixth embodiment of the present disclosure.

FIG. 17 is a schematic diagram of a state of use of the sixth embodiment of the present disclosure.

### DETAILED DESCRIPTION OF THE INVENTION

An engaging connection structure according to the embodiments of the present disclosure is further described with the accompanying drawings below.

The above and other technical details, features and effects of the disclosure will become more apparent with the detailed description of the preferred embodiments with reference to the drawings below. It should be noted that, the directional terms used in the embodiments below, for example, upper, lower, left, right, front and back are provided merely with reference to the directions of the accompanying drawings. Thus, the directional terms are for illustration purposes and are not to be construed as limitations to the present disclosure. Moreover, in the embodiments below, the same or similar components are denoted with the same or similar symbols or numerals.

To facilitate understanding of the object, characteristics and effects of the present disclosure, embodiments together with the attached drawings for the detailed description of the present disclosure are provided below.

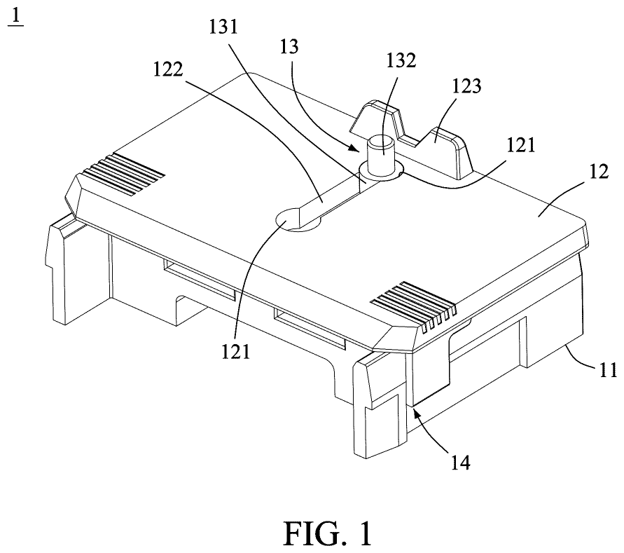

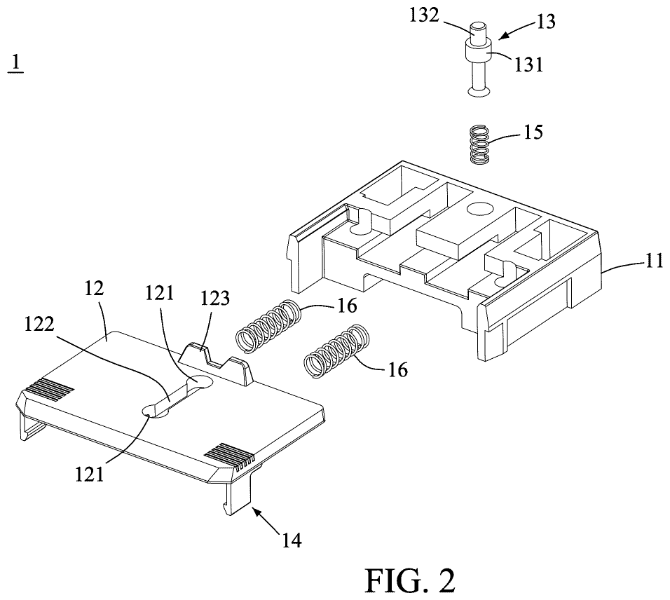

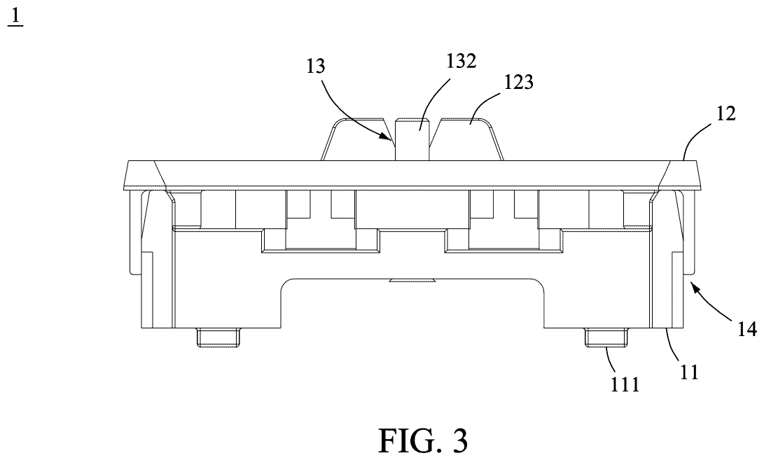

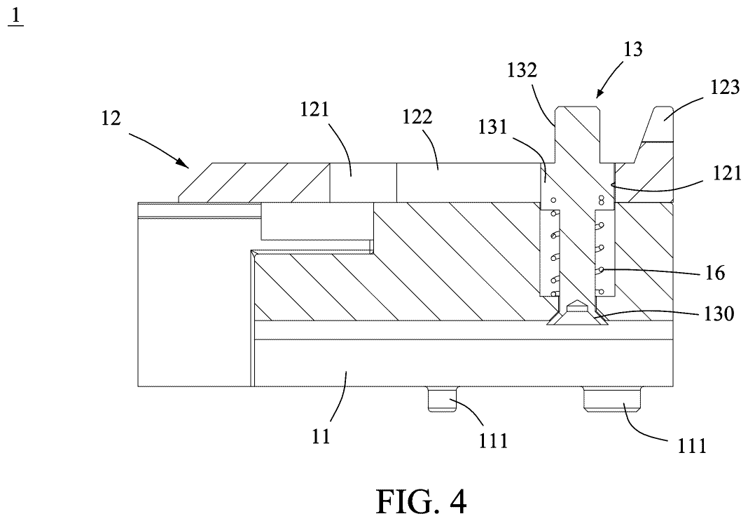

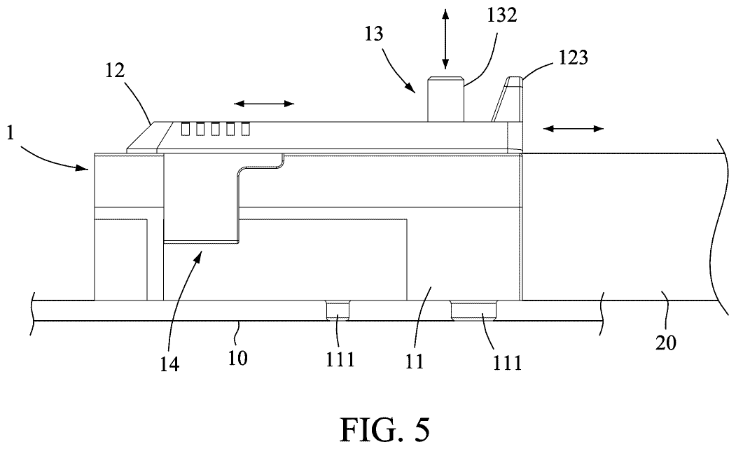

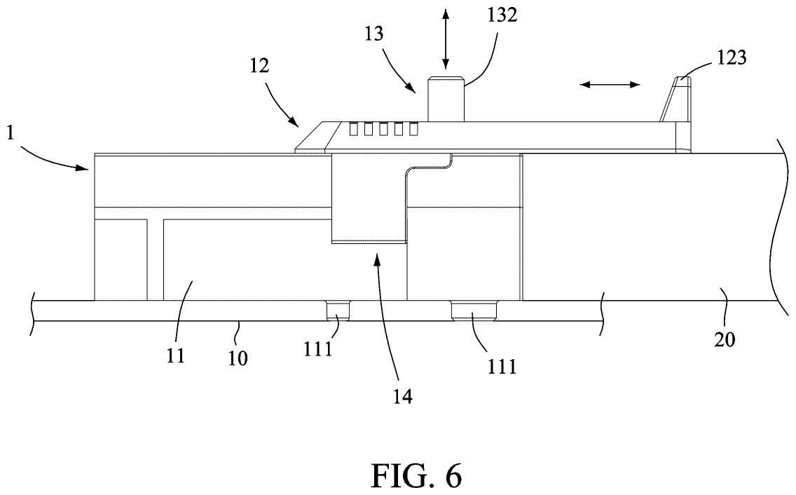

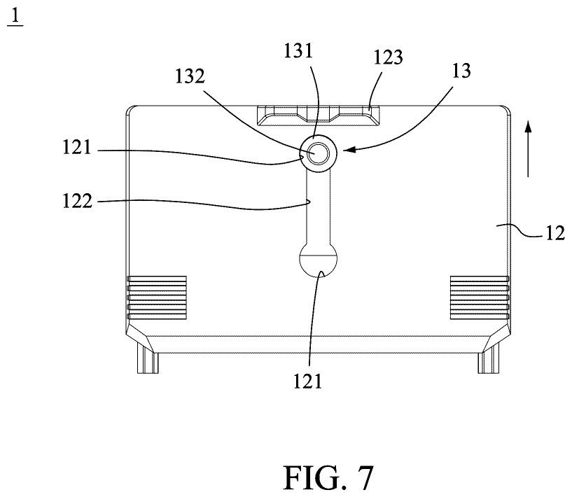

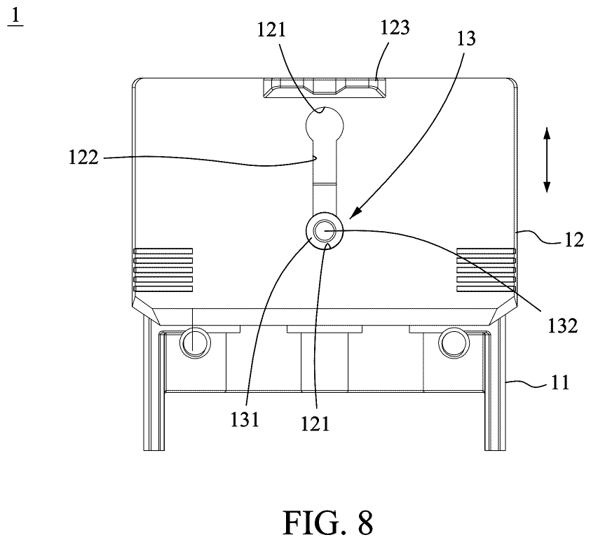

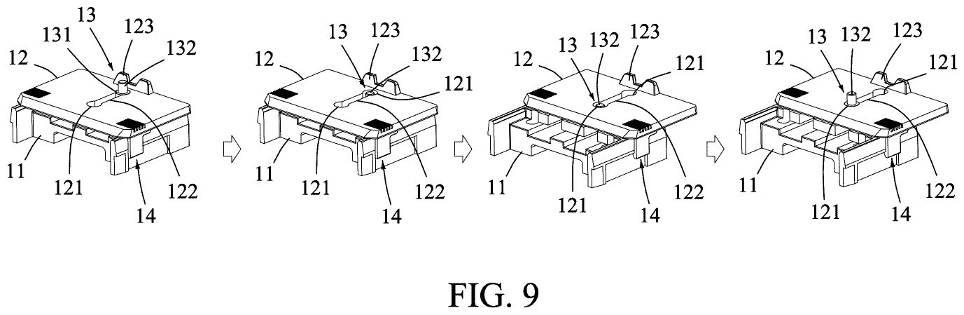

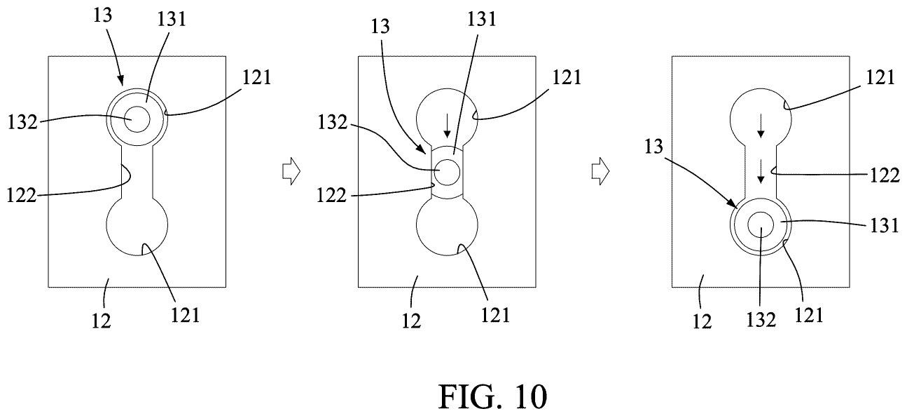

Referring to FIG. 1 to FIG. 10, as shown in the drawings, the present disclosure provides an engaging connection structure 1 including an assembly portion 11, an engaging portion 12 and a limiting member 13.

The engaging portion 12 is movably combined with the assembly portion 11.

The limiting member 13 is provided at the assembly portion 11 and the engaging portion 12. The engaging portion 12 is provided with at least one positioning portion 121 and a moving portion 122. The limiting member 13 provides limiting or moves at the positioning portion 121 and the moving portion 122 to limit a movement of the engaging portion 12.

During use, the engaging connection structure 1 may be combined with the object 10 by the assembly portion 11, then another object 20 is provided on the object 10, and the limiting member 13 is pressed downward, such that the engaging portion 12 moves to allow the limiting member 13 to move in the positioning portion 121 and the moving portion 122 to perform limiting, hence limiting the movement of the engaging portion 12 and engaging the engaging portion 12 with the another object 20. To separate the another object 20, the limiting member 13 is similarly pressed downward to move the engaging portion 12 in reverse and allow the limiting member 13 to move in the positioning portion 121 and the moving portion 122 to perform limiting, such that the engaging portion 12 is released from the another object 20. Thus, the assembly portion 11 can be combined with the object 10, and be engaged with or released from the another object 20 with the engaging portion 12 coordinating with the limiting member 13, so as to complete quick coupling and separation of at least two objects to achieve effects of repeatedly quick coupling and separation.

In addition to the embodiment above, in one embodiment of the present disclosure, the assembly portion 11 may also be provided with at least one positioning portion 121 and a moving portion 122 as needed. The limiting member 13 provides limiting or moves at the positioning portion 121 and the moving portion 122 to limit a movement of the engaging portion 12. Thus, the present disclosure can better meet actual application requirements.

In addition to the embodiment above, in one embodiment of the present disclosure, the differences from the embodiments above are that, the assembly portion 11 is provided with a mounting unit 111, and the assembly portion 11 may be mounted at the object 10 by the mounting unit 11 by means of engaging connection, locking, welding, expansion connection or riveting. Or, the assembly portion 11 and the object 10 may be integrally formed. Thus, the assembly portion 11 may be securely arranged at the object 10 to facilitate moving operations of the engaging portion 12 and the limiting member 13.

In addition to the embodiment above, in one embodiment of the present disclosure, the differences from the embodiments above are that, a limiting portion 14 is provided between the engaging portion 12 and the assembly portion 11, wherein the limiting portion 14 is for limiting or movable combination. Thus, the limiting portion 14 may be served for guidance or travel limitation of movements of the engaging portion 12 on the assembly portion 11, thereby achieving an effect of smooth movements to facilitate locking or unlocking operations.

In addition to the embodiment above, in one embodiment of the present disclosure, the differences from the embodiments above are that, the engaging portion 12 is provided with an operating portion 123. The operating portion 123 is for being operated, lifted, or actuated to the engaging portion 12 of the engaging connection structure 1.

In addition to the embodiment above, in one embodiment of the present disclosure, the differences from the embodiments above are that, a first elastic component 15 is further included. Two ends of the first elastic component 15 abut against the assembly portion 11 and the limiting member 13, respectively (or two ends of the first elastic component 15 abut against the engaging portion 12 and the limiting member 13, respectively), the first elastic component 15 abuts against the limiting member 13 such that the limiting member 13 is located at the positioning portion 121 and the engaging portion 12 forms a limited state, or the limiting member 13 is pressed downward to compress the first elastic component 15 such that the limiting member 13 forms a moving state via the moving portion 12.

In addition to the embodiment above, in one embodiment of the present disclosure, the differences from the embodiments above are that, at least one second elastic component 16 is further included. Two ends of the second elastic component 16 abut against the assembly portion 11 and the engaging portion 12, respectively, such that the engaging portion 12 is automatically engaged or automatically released due to an elastic force of the second elastic component 16. For example, the second elastic component 16 forms a compressed state when the engaging portion 12 is released, and the engaging portion 12 is automatically engaged due to recovery of the elastic force.

In addition to the embodiment above, in one embodiment of the present disclosure, the differences from the embodiments above are that, the limiting member 13 is provided with a limiting portion 131 and a non-limiting portion 132. The volume or size of the limiting portion 13 is adapted to provide limiting at the positioning portion 121, and the volume or size of the non-limiting portion 132 is adapted to move at the moving portion 122.

In addition to the embodiment above, in one embodiment of the present disclosure, the differences from the embodiments above are that, the positioning portion 121 is greater than the limiting portion 131, the limiting portion 131 is greater than the moving portion 122, and the moving portion 122 is greater than the non-limiting portion 132.

In addition to the embodiment above, in one embodiment of the present disclosure, the differences from the embodiments above are that, the positioning portion 121 is a wide hole portion, the number of the positioning portion 121 is two, the moving portion 122 is communicatively provided between the two positioning portions 121, and the non-limiting portion 132 moves downward to release one of the positioning portions 121 from limiting of the limiting portion 131, such that the non-limiting portion 132 moves at the moving portion 122, or the limiting portion 131 provides limiting at the other of the positioning portions 121.

In addition to the embodiment above, in one embodiment of the present disclosure, the differences from the embodiments above are that, the limiting member 13 is provided with a block portion 130. The block portion 130 is for blocking against the engaging portion 12 to combine the assembly portion 11 with the engaging portion 12, and for supporting an elastic force of the first elastic component 15 to elastically abut the limiting member 13 at the engaging portion 12.

On the basis of the embodiment above, during use, the limiting member 13 may be pressed downward to compress the first elastic component 15, such that the non-limiting portion 132 moves downward and is released from limiting of one of the positioning portions 121 to locate the non-limiting portion 132 at the position of the one of the positioning portions 121, and at the same time the non-limiting portion 132 is caused to correspond to the moving portion 122 to pull or push the operating portion 123 when a force is applied such that the non-limiting portion 132 can move at the moving portion 122. Meanwhile, the second elastic component 16 is compressed to engage the engaging portion 12 with the another object 20, and the other of the positioning portions 121 is caused to correspond to the non-limiting portion 132 after the engaging. Moreover, due to recovery of the elastic force of the first elastic component 15, the limiting portion 131 is moved upward to the other positioning portion 121 and is limited, so as to complete engaging connection of the another object 20.

To separate the another object 20, the limiting member 13 is similarly pressed downward to compress the first elastic component 15, such that the non-limiting portion 132 moves downward and is released from limiting of the other of the positioning portions 121 to locate the non-limiting portion 132 at the position of the one of the positioning portions 121, and at the same time the non-limiting portion 132 is caused to correspond to the moving portion 122 to allow the non-limiting portion 132 to move at the moving portion 122. Meanwhile, with the elastic force of the second elastic component 16, the engaging portion 12 is automatically released from the another object 20, and the one of the positioning portions 121 is caused to correspond to the non-limiting portion 132 after the release. Moreover, due to recovery of the elastic force of the first elastic component 15, the limiting portion 131 is moved upward to the one of the positioning portions 121 and is limited, so as to complete the release of the another object 20. Thus, the assembly portion 11 can be combined with the object 10, and be engaged with or released from the another object 20 with the engaging portion 12 coordinating with the limiting member 13, so as to complete quick coupling and separation of at least two objects to achieve effects of repeatedly quick coupling and separation.

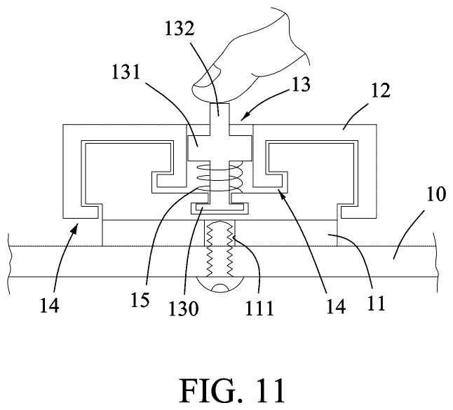

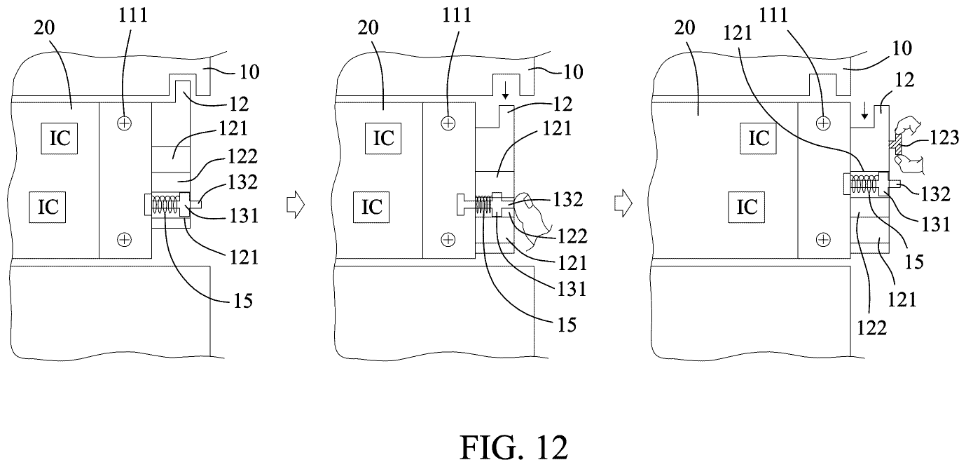

Referring to FIG. 11 and FIG. 12, in addition to the embodiments above, in one embodiment of the present disclosure, the differences from the embodiments above are that, the object 10 may be a server, a computer, a motherboard, a PCB, a housing, a track, a heat dissipater, a fan, a memory, a chip, a metal body or a non-metal body, and the another object 20 may be a circuit board, an IC, a chip, a PCB, a housing, a track, a heat dissipater, a fan, a metal body, a plastic body, a non-metal body, a heat sink or a memory. Thus, the engaging connection structure 1 of the present disclosure can better meet actual application requirements.

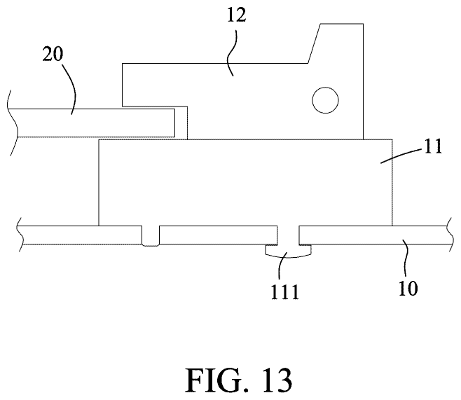

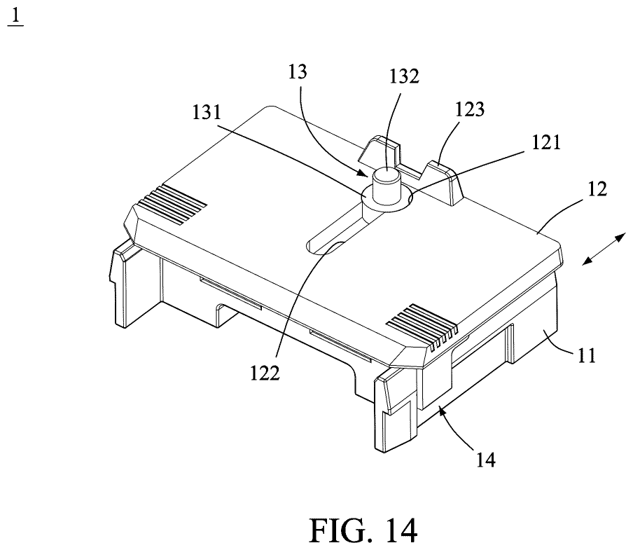

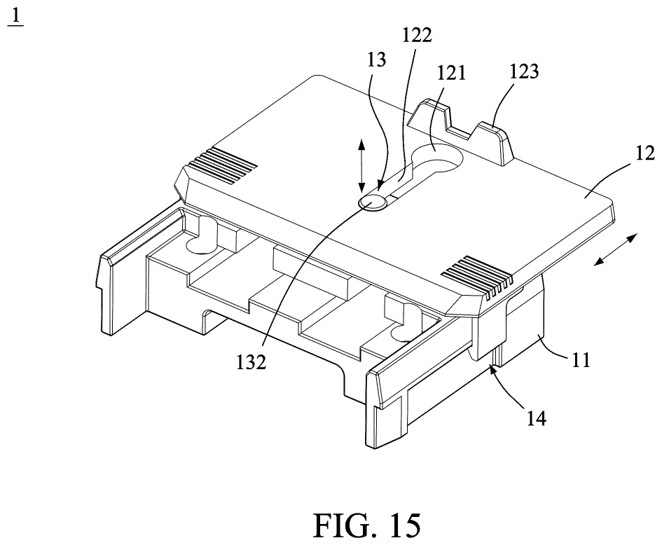

Referring to FIG. 13 to FIG. 15, in addition to the embodiments above, in one embodiment of the present disclosure, the differences from the embodiments above are that, the number of the positioning portion 121 is one, the limiting member 13 moves at the moving portion 122 and departs from the positioning portion 121 to locate the engaging portion 12 at a normally engaged position or a normally open position, such that the engaging portion 12 is automatically engaged or automatically released due to an elastic force of the second elastic component 16, or to engage or release the engaging portion 12 with or from the positioning portion 121 at the moving portion 122. For example, the second elastic component 16 forms a compressed state when the engaging portion 12 is released, and the engaging portion 12 is automatically engaged due to recovery of the elastic force.

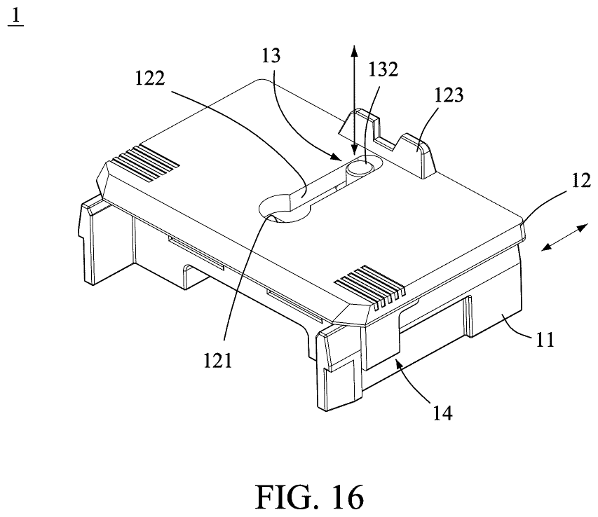

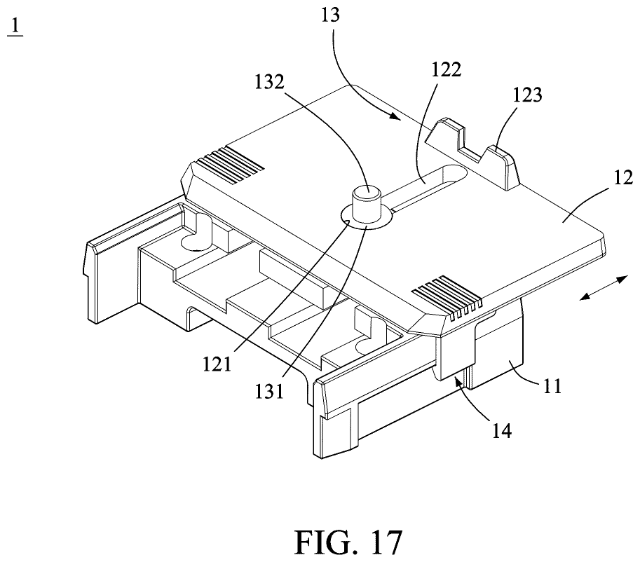

Referring to FIG. 16 and FIG. 17, on the basis of the embodiment above, during use, the limiting member 13 may be pressed downward to compress the first elastic component 15, such that the non-limiting portion 132 moves downward and departs from limiting of the positioning portion 121 to locate the non-limiting portion 132 at the position of the positioning portion 121, and at the same time the non-limiting portion 132 is caused to correspond to the moving portion 122 to pull or push the operating portion 123 when a force is applied to allow the non-limiting portion 132 to move at the moving portion 122. Meanwhile, the second elastic component 16 is compressed to engage the engaging portion 12 with the another object 20, and one sidewall of the moving portion 122 is caused to correspond to the non-limiting portion 132 after the engaging. Moreover, due to recovery of the elastic force of the first elastic component 15, the limiting portion 131 is allowed to move upward to the one sidewall of the moving portion 122 and is limited, so as to complete the engaging of the another object 20.

To separate the another object 20, the limiting member 13 is similarly pressed downward to compress the first elastic component 15, such that the non-limiting portion 132 moves downward and is released from the limiting of the one sidewall of the moving portion 122 to locate the non-limiting portion 132 at the position of the positioning portions 121, and at the same time the non-limiting portion 132 is caused to correspond to the moving portion 122 to allow the non-limiting portion 132 to move at the moving portion 122. Meanwhile, with the elastic force of the second elastic component 16, the engaging portion 12 is released from the another object 20, and the positioning portion 121 is caused to correspond to the non-limiting portion 132 after the release. Moreover, due to recovery of the elastic force of the first elastic component 15, the limiting portion 131 is moved upward to the positioning portion 121 and is limited, so as to complete the release of the another object 20. Thus, the assembly portion 11 can be combined with the object 10, and be engaged with or released from the another object 20 with the engaging portion 12 coordinating with the limiting member 13, so as to complete quick coupling and separation of at least two objects to achieve effects of repeatedly quick coupling and separation.

In addition to the embodiment above, in one embodiment of the present disclosure, the differences from the embodiments above are that, the block portion 130 blocks against the assembly portion 11 to support an elastic force of the first elastic component 15, so as to elastically abut the limiting member 13 at the assembly portion 11. Thus, the engaging connection structure 1 of the present disclosure can better meet actual application requirements.

In conclusion, in the engaging connection structure and the engaging connection method thereof of the present disclosure, an assembly portion can be combined with an object, and be engaged with or released from another object with the engaging portion coordinating with a limiting member, so as to complete quick coupling and separation of at least two objects to achieve effects of repeatedly quick coupling and separation.

It should be noted that the embodiments of the present disclosure are described above for illustration purposes and are not to be construed as limitations to the scope of the claims of the present disclosure.

What is claimed is:

1. An engaging connection structure, comprising:
an assembly portion;
an engaging portion, movably combined with the assembly portion; and
a limiting member, for being provided at the assembly portion and the engaging portion; or the engaging portion being provided with at least one positioning portion and a moving portion; or the limiting member limiting or moving at the positioning portion and the moving portion to limit a movement of the engaging portion; or the assembly portion being provided with at least one positioning portion and a moving portion; or the limiting member providing limiting or moving at the positioning portion and the moving portion to limit a movement of the engaging portion.

2. The engaging connection structure according to claim 1, further comprising a first elastic component, wherein two ends of the first elastic component abut against the assembly portion and the limiting member, respectively, the first elastic component abuts against the limiting member such that the limiting member is located at the positioning portion and the engaging portion forms a limited state, or presses the limiting member downward to compress the first elastic component such that the limiting member forms a moving state via the moving portion.

3. The engaging connection structure according to claim 1, further comprising a first elastic component, wherein two ends of the first elastic component abut against the engaging portion and the limiting member, respectively, the first elastic component abuts against the limiting member such that the limiting member is located at the positioning portion and the engaging portion forms a limited state, or presses the limiting member downward to compress the first elastic component such that the limiting member forms a moving state via the moving portion.

4. The engaging connection structure according to claim 1, further comprising at least one second elastic component, wherein two ends of the second elastic component abut against the assembly portion and the engaging portion, respectively; or further comprising at least a second elastic component, wherein two ends of the second elastic component abut against the assembly portion and the engaging portion, respectively, the limiting member moves at the moving portion and departs from the positioning portion, such that the engaging portion is automatically engaged or automatically released due to an elastic force of the second elastic component or to locate the engaging portion at a normally engaged position or a normally open position, or the number of the positioning portion is one, the limiting member moves at the moving portion and departs from the positioning portion, such that the engaging portion is automatically engaged or automatically released due to an elastic force of the second elastic component, or to locate the engaging portion at a normally engaged position or a normally open position.

5. The engaging connection structure according to claim 1, wherein the positioning portion is a wide hole portion.

6. The engaging connection structure according to claim 1, wherein the limiting member is provided with a limiting portion and a non-limiting portion, a volume or size of the limiting portion is adapted to provide limiting at the positioning portion, and a volume or size of the non-limiting portion is adapted to move at the moving portion.

7. The engaging connection structure according to claim 1, wherein the limiting member is provided with a limiting portion and a non-limiting portion, the non-limiting portion moves downward to release the positioning portion from limiting of the limiting portion, such that the non-limiting portion moves at the moving portion, or the limiting portion provides limiting at another positioning portion, or the number of the positioning portion is two, the moving portion is communicatively provided between the two positioning portions, and the non-limiting portion moves downward to release one of the positioning portions from limiting of the limiting portion, such that the non-limiting portion moves at the moving portion, or the limiting portion provides limiting at the other of the positioning portions.

8. The engaging connection structure according to claim 1, wherein the limiting member is provided with a limiting portion and a non-limiting portion, the positioning portion is greater than the limiting portion, the limiting portion is greater than the moving portion, and the moving portion is greater than the non-limiting portion.

9. The engaging connection structure according to claim 1, wherein the assembly portion is provided with a mounting unit, and the mounting unit is for assembling at an object, which is a server, a computer, a motherboard, a printed circuit board (PCB), a housing, a track, a heat dissipater, a fan, a memory, a chip, a metal body or a non-metal body.

10. The engaging connection structure according to claim 1, wherein the engaging portion is for engaging another object, which is a circuit board, an integrated circuit (IC), a chip, a PCB, a housing, a track, a heat dissipater, a fan, a metal body, a plastic body, a non-metal body, a heat sink or a memory; or a limiting portion is provided between the engaging portion and the assembly portion, wherein the limiting portion is for limiting or movable combination, or the assembly portion is for being engagingly connected, locked, welded, expansion connected or riveted to the object, or the assembly portion and the object are integrally formed.

11. The engaging connection structure according to claim 1, wherein the engaging portion is provided with an operating portion, which is for being operated, lifted, or actuated to the engaging connection structure.

12. The engaging connection structure according to claim 1, wherein the limiting member moves at the moving portion and departs from the position portion to locate the engaging portion at a normally engaged position or a normally open position, or to allow the engaging portion to be engaged with or released from the positioning portion at the moving portion; or the limiting member is provided with a block portion, which is for blocking against the assembly portion or the engaging portion to combine the assembly portion with the engaging portion, or for supporting an elastic force of the first elastic component to elastically abut the limiting member at the engaging portion or the assembly portion.
